(19) United States
(12) Patent Application Publication
(10) Pub. No.: US 2007/0017951 A1
(43) Pub. Date: Jan. 25, 2007

(54) Wrap saver

(76) Inventor: Kim Martin, Miami, FL (US)

Correspondence Address: Galasso & Associates, LP, P.O. Box 26503, Austin, TX, 78755-0503, US

(21) Appl. No.: 11/186,499

(22) Filed: Jul. 21, 2005

(51) Int. Cl. B26F 3/02

(52) U.S. Cl. 225/44; 225/45

(57) ABSTRACT

A storage container that operates to hold various types of dispensing materials. The storage container allows the user to select the size of the dispensing material to be placed into the storage container by offering a slideable connection. Once the size of the dispensing material is determined the user can place the dispensing material such as plastic, aluminum or paper into the storage container wherein the dispensing material is held into place by way of an extended triangular locking piece. The extended triangular locking piece operates on a spring load system that allows for the dispensing material to be placed into the storage container by applying pressure to the extended triangular locking piece. The storage container is designed with a jagged tooth edge that allows the dispensing material to be cut by applying pressure over the jagged tooth edge. Additionally, the lid of the storage container is designed with a weighted lip that functions to automatically close.

### FIELD OF THE DISCLOSURE

The present invention relates to a storage container operable to hold various kinds of wraps such as plastic, aluminum or paper.

### BACKGROUND

Almost every adult has bought some form of container containing a plastic wrap, aluminum or paper in their life. These are very popular items in every household. However, the dispensers are not always as easy to use as they may appear.

The current dispensers are typically a cardboard box wherein the front contains some form of cutting edge. The box is normally sealed and contains weakened severing connections on each end as described in U.S. Pat. No. 3,002,667. Under ideal conditions, this offers an easy means of opening the box; however, the glue that actually seals the box sometimes extends to areas where it is not supposed to be creating difficulty in opening the box. Alternatively, the weakened severing connections do not always tear apart as they are designed. This leaves you with a section that is either cut off or contains additional material depending on how the weakened severing connections tear apart. This is only part of the problems associated with the current method of dispensing wraps.

If you have ever used plastic wrap, you have obviously experienced some degree of difficulty in getting the wrap to actually dispense from the roll. Because the current cardboard box method of dispensing wrap allows the roll of wrap to come out of the box, it sometimes makes if very difficult to dispense certain wraps such as plastic wrap. The plastic wrap has a tendency to stick to the roll making the dispensing more difficult. Therefore, you are required to use one hand to hold the lid of the box closed while using the other than hand to actually pull the wrap from the box. Once you have actually managed to get the wrap to unroll and you have reached your desired length, you are then faced with trying to cut the wrap from the roll. The difficulty with plastic wrap is that when you attempt to do this with one hand you end up with the wrap getting bunched up once it is cut. Now you are faced with trying to unstick the wrap from itself on the newly cut piece.

While aluminum does not have quite as many problems with dispensing as plastic wrap, it too has its share of problems with the cardboard box. For example, if the ends get crushed on the aluminum, it makes dispensing difficult. It is easy for the ends of the box to be crushed when the boxes are stored in a drawer. With the movement of the draw it allows the box to slide back and forth causing the wrap to slide back and forth within the box. Additionally, when you place these cardboard boxes into a drawer it easy for other objects in the drawer to create problems with the box. Additionally, aluminum comes in more than one size. Sometimes, the wider size is not easily placed in a drawer.

Alternatively, the tops to the various types of wrap boxes do not always stay closed. Therefore, when they are placed in a drawer for storage, you are taking the chance that the top will open while in the drawer. If this happens, the top is likely to become at least partially crushed when you try to open the drawer. At the very least, an open top, creates a problem for the user in trying to get the box out of the drawer.

Another means of wrapping is paper. While we do not always think of paper as a wrapping means in the kitchen, we do use paper to wrap lots of things. Packages are probably the most common. If we are not wrapping packages for gifts, we have all wrapped a package at some point for shipping. Keeping the brown paper that is used for wrapping shipping packages is as difficult as keeping wrapping paper from getting all bunched up. Neither brown wrapping paper nor gift wrap paper currently comes in dispensers similar to those used for plastic wrap or aluminum.

### SUMMARY OF THE DISCLOSURE

In one embodiment the storage container would be comprised of at least two pieces.

In another embodiment the at least two pieces will be operable to connect.

In another embodiment at least one of the two pieces will comprise a groove on the bottom side.

In still another embodiment the first and second pieces will be slideably connectable by means of the groove.

In still another embodiment the at least two pieces will lock together at the desired length.

In another embodiment the storage container will include a jagged tooth edge.

In yet another embodiment the jagged tooth edge would be operable to cut a material when pressure is applied.

In another embodiment the storage container would comprise two end pieces each having an extended triangular locking piece.

In another embodiment the extended triangular locking pieces would be spring loaded.

In still another embodiment the extended triangular locking pieces would be operable to hold a round tube.

In yet another embodiment the extended triangular locking pieces would be operable to allow a round tube to rotate.

In yet another embodiment the storage container would be comprised of chrome

In still another embodiment the storage container would be comprised of plastic.

In another embodiment the storage container would be comprise a top side which is hinged to the back side.

In another embodiment the storage container would comprise a lip.

In yet another embodiment the lip of the storage container would be thicker to cause the lip to close automatically.

In still another embodiment the storage container would comprise rounded corners.

In another embodiment the storage container would be constructed of chrome.

In still another embodiment the storage container would be constructed of hard plastic.

In another embodiment the storage container would be operable to hold aluminum foil.

In yet another embodiment the storage container would be operable to hold plastic wrap.

In still another embodiment the storage container would be operable to hold rolled paper.

Still other advantages of various embodiments will become apparent to those skilled in this art from the following description wherein there is shown and described preferred embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIG. 1 illustrates the two pieces showing the grooved section of one of the pieces that allows the two pieces to slideably connect. It further illustrates the spring locking mechanism on one of the end pieces.

FIG. 2 illustrates the extended triangular locking mechanism that allows the tube of material to rotate while holding the tube in place.

FIG. 3 is a bottom view showing the grooved area for sliding the two pieces together.

FIG. 4 illustrates the back side wherein the locking mechanism that holds the two pieces is shown.

FIG. 5 illustrates a front view of the open storage container wherein the jagged tooth edge is shown and the two pieces are connected.

### DETAILED DESCRIPTION OF THE DRAWING FIGURES

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

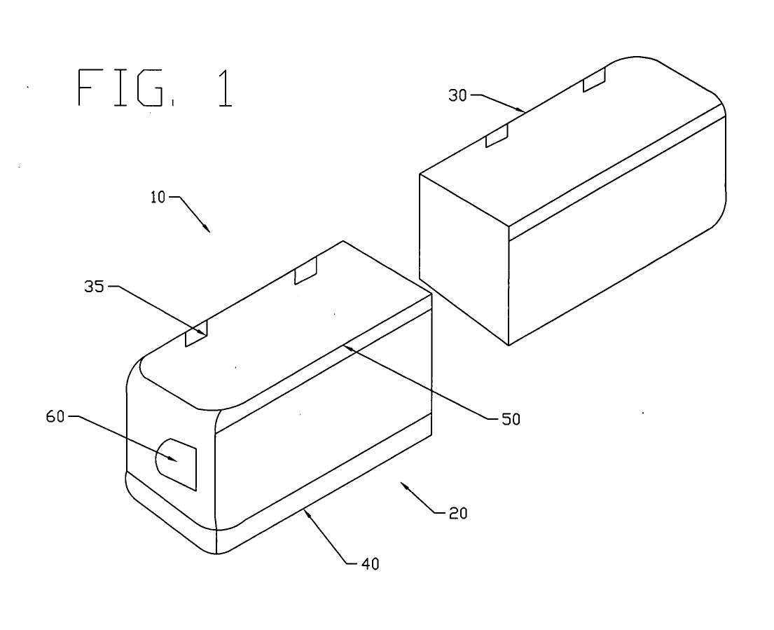

FIG. 1 illustrates a storage container 10 comprising a first piece 20, a second piece 30, a hinge mechanism 35, a groove 40, a lip 50, and a spring load system 60. The first piece 20 operates to receive the second piece 30 by way of the groove 40. Once the first piece 20 and second piece 30 mate, the first piece 20 and the second piece 30 are slideably adjustable. By adjusting the length of the storage container 10, the storage container 10 can accommodate various sizes of paper, plastic wrap or aluminum. The most common use of this type of storage container would be for use with plastic wrap or aluminum. However, paper such as brown wrapping paper for mailing packages or gift wrap would be an alternative use for the storage container 10. Not only would the storage container 10 serve to keep these types of wraps from being torn or wrinkled, it would allow for easy dispensing. Once the storage container 10 was adjusted to the proper length for the desired wrap, the roll of wrap is placed inside by way of the spring load system 60 and is then ready for dispensing. The hinge mechanism 35 operates to allow the storage container 10 to be opened allowing for the insertion of the dispensing material.

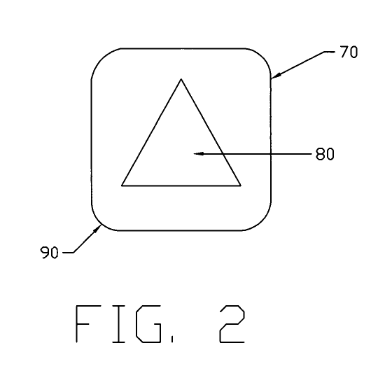

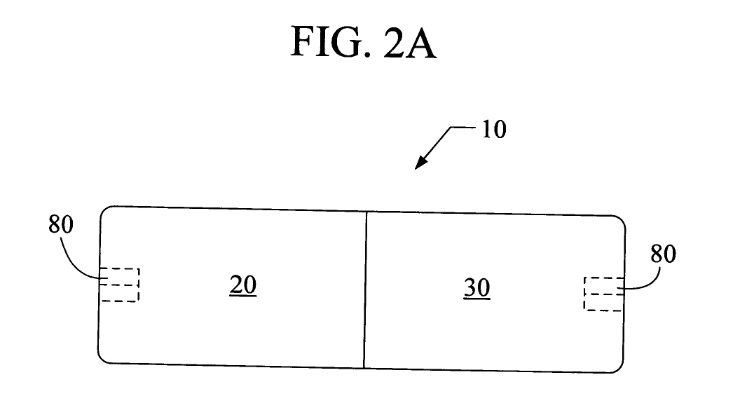

FIG. 2 illustrates an inside view of the end piece 70 wherein the triangular locking piece 80 is shown. The triangular locking piece 80 is designed to hold a tube of the dispensing material whether plastic wrap, aluminum or paper. The triangular locking piece 80 operates off of a spring load system 60 which allows the triangular locking piece 80 to retract when placed under pressure. This allows the tube of a dispensing material to be inserted into the storage container 10 and held into place once it is inserted. By the triangular locking piece 80 being on a spring load system 60, the tube of dispensing material is locked into the storage container 10 and eliminates the burden of trying to hold the storage container 10 closed during dispensing to prevent the tube of dispensing material from coming out of the storage container 10. FIG. 2 also illustrates the rounded corners 90 of the storage container 10.

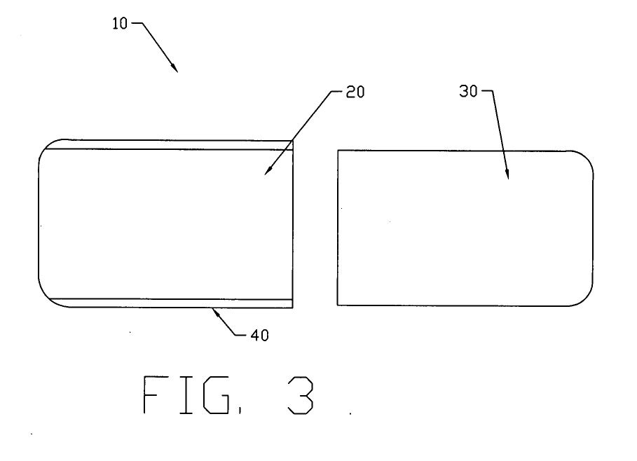

FIG. 3 illustrates a bottom view of the storage container 10, wherein the first piece 20, and a second piece 30 are slideably connectable by mating the first piece 20 with the second piece 30 by means of the groove 40. This allows the storage container 10 to be adjusted to the desired length based on the user's need for the storage container. For example, should the user desire to use the storage container 10 for plastic wrap, the storage container 10 would be adjusted to fit the size of the plastic wrap. However, should the user desire to use the storage container 10 for extra wide aluminum foil, the storage container 10 could be adjusted to fit that width.

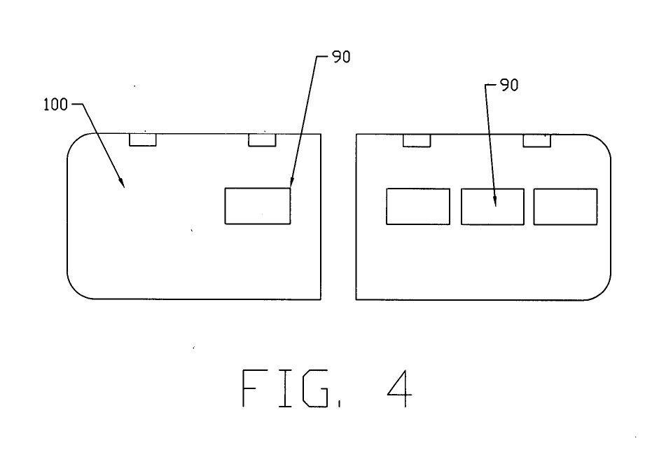

FIG. 4 illustrates a back view of the storage container 10, wherein the locking mechanism 90 is located on the back side 100 of storage container 10. The locking mechanism 90 is designed to hold the first piece 20 and the second piece 30 together once the first piece 20 and the second piece 30 mate. Additionally, the locking mechanism 90 is designed to hold the first piece 20 and the second piece 30 at the desired length of the internal contents.

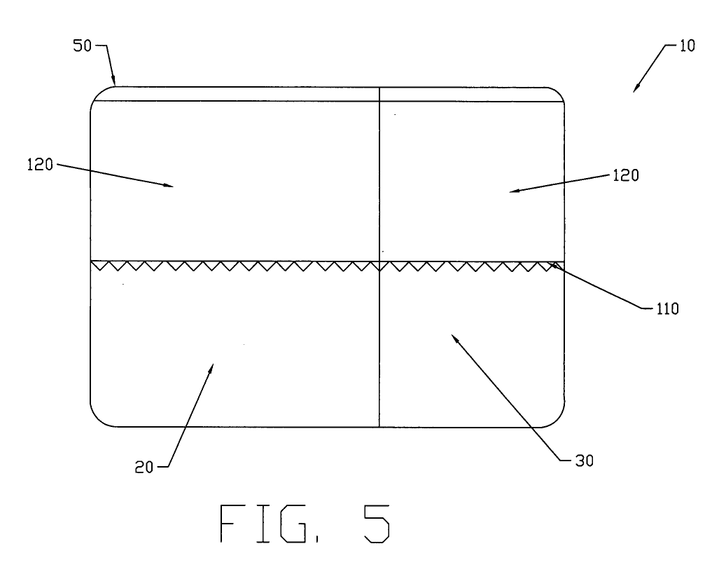

FIG. 5 is a front view of an open storage container 10 wherein the first piece 20 and the second piece 30 are mated. Additionally, FIG. 5 illustrates the jagged tooth edge 110 that operates to cut the dispensing material when pressure is applied along the jagged tooth edge 110. FIG. 5 further illustrates the lip 50. The lip 50 functions to cover the jagged tooth edge 110 when the top side 120 is in the closed position. Further, the lip 50 is constructed of a thicker material which functions to cause the top side 120 to close automatically. By having the lip 50 automatically close the storage container 10, it prevents the storage container 10 from coming open when stored. Should the storage container 10 be stored in a drawer, the lip 50 would prevent the storage container 10 from becoming lodged inside the drawer.

1. A rectangular plastic storage container for removably storing a material disposed on a round tube comprising:
a first piece and a second piece wherein said first and second pieces each comprise a top side, a bottom side, front side, a front lip, a back side and an end piece;
a grooved area along the bottom of said first piece operable to allow said second piece to slide into the grooved area;
a locking mechanism on the back of said first and second piece operable to lock said first piece and said second piece together;
said first piece and second piece further comprising a jagged tooth edge along an upper edge to cut the material when pressure is applied; and
extended triangular locking pieces retractable from a first locked position wherein said locking pieces hold the round tube to a second unlocked position wherein the round tube may be moved toward and between said locking pieces or away from said locking pieces and the storage container; and wherein said locking pieces are operatively configured to allow the round tube to rotate such that the material disposed on the round tube can be unraveled and removed from the storage container after being cut by said jagged tooth edge.

2. (canceled)

3. A storage container of claim 1, wherein said first piece and said second piece are slideably adjustable by way of the locking mechanism and the grooved area.

4. A rectangular plastic storage container of claim 1, wherein the locking mechanism is operable to allow said first piece and said second piece to be adjusted to different lengths.

5. A rectangular plastic storage container of claim 1, further comprising the extending triangular locking piece on each end wherein the extending triangular locking pieces comprise a spring load system allowing the triangular pieces to retract for loading.

6. A rectangular plastic storage container of claim 1, wherein the top side comprises a hinge mechanism operable to allow the top to open and close.

7. A rectangular plastic storage container of claim 1, wherein the front lip portions are thicker than the top side portions and back side portions creating a weighted edge causing the storage container top to automatically close.

8. (canceled)

9. A storage system for removably storing a material disposed on a round tube comprising:
said round tube having a material disposed around said tube in a wrap configuration wherein said material can be unraveled from said tube;
a rectangular storage container for removably storing said tube and said material including:
a first piece and a second piece wherein said first and second pieces each comprise a top side; a bottom side, front side, a front lip, a back side and an end piece, the rectangular storage container having four corners;
a grooved area along the bottom of said first piece operable to allow said second piece to slide into the grooved area;
a locking mechanism on the back of said first and second piece operable to lock said first piece and said second piece together;
said first piece and second piece further comprising a jagged tooth edge along an upper edge to cut the material when pressure is applied; and
extended triangular locking pieces retractable from a first locked position wherein said locking pieces hold said round tube to a second unlocked position wherein said round tube may be moved toward and between said locking pieces or away from said locking pieces and the storage container; and wherein said locking pieces are operatively configured to allow said round tube to rotate such that said material disposed on the round tube can be unraveled and removed from the storage container after being cut by said jagged tooth edge.

10. A plastic storage container of claim 9, wherein said first piece and said second piece slide to create an extended rectangular container.

11. A plastic storage container of claim 9, wherein the corners are rounded.

12. A plastic storage container of claim 9, wherein the extended triangular locking piece operates on a spring mechanism allowing the extended triangular locking piece to retract when pressure is applied.

13. A storage system container of claim 9 wherein the container is comprised of chrome.

14. A storage system container of claim 9, wherein the container is comprised of hard plastic.
